(19) United States
(12) Patent Application Publication
(10) Pub. No.: US 2026/0036823 A1
(43) Pub. Date: Feb. 5, 2026

(54) CAMERA STRUCTURE

(71) Applicant: Luxshare Intelligent Manufacture Technology (Changshu) Co., Ltd, Changshu City (CN)

(72) Inventors: Li-Jhen Chen, Taipei City (TW); Po-Ying TSENG, Taipei City (TW); Ngoc-Luong NGUYEN, Changshu City (CN)

(73) Assignee: Luxshare Intelligent Manufacture Technology (Changshu) Co., Ltd, Changshu City (CN)

(21) Appl. No.: 19/284,190

(22) Filed: Jul. 29, 2025

(30) Foreign Application Priority Data
Jul. 30, 2024 (CN) 202411034614.1

(51) Int. Cl. G02B 27/64; G02B 7/08

(52) U.S. Cl. CPC G02B 27/646; G02B 7/08

(57) ABSTRACT

A camera structure includes a moving structure with a first moving portion, a second moving portion, and a moving element. The moving element includes a first end face, a second end face, and an inclined lateral surface. The surface extends and connects from a peripheral side of the first end face to a peripheral side of the second end face. The first moving portion has a first groove, the groove bottom of the first groove is the first surface. The second moving portion has a second groove, the groove bottom of the second groove is the second surface. The inclined lateral surface of the moving element abuts the first surface. Another side of the inclined lateral surface of the moving element abuts the second surface. The moving element moves on the first surface and the second surface, and the imaging lens is displaced by the moving structure.

### CROSS REFERENCE TO RELATED APPLICATION

This application claims the priority benefit of Chinese Patent Application Serial Number 202411034614.1, filed on Jul. 30, 2024, the full disclosure of which is incorporated herein by reference.

### BACKGROUND

### 1. Technical Field

The present invention relates to the technical field of camera technology, and particularly to a camera structure.

### 2. Description of the Related Art

Camera devices often feature anti-shake mechanisms to enhance image stability. When a user holds the camera for capturing images, unsteady shaking or vibrations can negatively impact the quality of the images. Optical image stabilization technology helps counteract these effects, leading to clearer, high-quality images. However, traditional systems typically employ a ball-type anti-shake design, where balls roll within a V-shaped groove. Over time, the multiple contact points between the balls and the groove can cause significant friction, leading to issues such as debris accumulation, dirt, and contamination.

### SUMMARY

In some embodiments, a camera structure includes a moving structure and an imaging lens. The moving structure includes a first moving portion, a second moving portion, and a moving element. The moving element is disposed between the first moving portion and the second moving portion. The moving element includes a first end face, a second end face, and an inclined lateral surface. The first end face is greater than the second end face. The inclined lateral surface extends and connects obliquely from a peripheral side of the first end face to a peripheral side of the second end face, the first moving portion has a first groove, the groove bottom of the first groove is a first surface, and the first surface forms an angle with respect to a peripheral side surface of an opening of the first groove. The second moving portion has a second groove, the groove bottom of the second groove is a second surface, and the second surface forms an angle with respect to a peripheral side surface of an opening of the second groove. The inclined lateral surface of the moving element abuts the first surface, and another side of the inclined lateral surface of the moving element abuts the second surface. The first moving portion and the second moving portion move relative to each other, the moving element moves on the first surface and the second surface, and an imaging lens is displaced by the moving structure.

According to one embodiment of the present invention, the first surface and the second surface are symmetrical with respect to a line connecting the center of the first end face and the center of the second end face of the moving element.

According to one embodiment of the present invention, the inclined lateral surface forms an angle of less than ninety degrees with the first end face, and the inclined lateral surface forms an angle of greater than ninety degrees with the second end face.

According to one embodiment of the present invention, the camera structure further includes a base assembly and a first moving assembly, the first moving assembly is disposed within the base assembly, the moving structure includes a first moving structure, the first moving structure is positioned between an inner wall of the base assembly and a corresponding outer wall of the first moving assembly, the base assembly has a first moving portion and a second moving portion, and the first moving structure guides the first moving assembly to move reciprocally in a first direction relative to the base assembly.

According to one embodiment of the present invention, the base assembly includes a base and a first coil, the first coil is disposed on the base, the first moving assembly includes a first moving body and a first magnet, the first magnet is disposed on the first moving body, the first coil corresponds to the first magnet, and a magnetic pole direction of the first magnet is parallel to the first direction.

According to one embodiment of the present invention, the base has a base accommodation trough, a trough side wall of the base accommodation trough has a first notch, the first coil is disposed within the first notch, the first moving body has a first accommodation trough, the first magnet is disposed within the first accommodation trough, and the position of the first notch corresponds to the position of the first accommodation trough.

According to one embodiment of the present invention, the camera structure further includes a second moving assembly, the moving structure includes a second moving structure, the second moving assembly is disposed within the first moving assembly, the second moving structure is positioned between the top portion of the first moving assembly and a corresponding bottom portion of the second moving assembly, the first moving assembly has a first moving portion, the second moving assembly has a second moving portion, the second moving structure guides the second moving assembly to move reciprocally in a second direction relative to the first moving assembly, and the second direction is perpendicular to the first direction.

According to one embodiment of the present invention, the camera structure further includes a lens base assembly, the moving structure includes a third moving structure, the lens base assembly is disposed on the second moving assembly, the third moving structure is positioned between a top portion of the second moving assembly corresponding to the bottom portion of the lens base assembly, the second moving assembly has a first moving portion, the lens base assembly has a second moving portion, the third moving structure guides the lens base assembly to move reciprocally in a third direction relative to the second moving assembly, and the third direction and the second direction are perpendicular to each other.

According to one embodiment of the present invention, the imaging lens is disposed on the lens base assembly.

According to one embodiment of the present invention, the base assembly includes a base and a second coil, the second coil is disposed on the base, the lens base assembly includes a lens base and a second magnet, the second magnet is disposed on the lens base, the second magnet corresponds to the second coil, and a magnetic pole direction of the second magnet is parallel to the second direction.

According to one embodiment of the present invention, the base has a base accommodation trough, a slot side wall of the base accommodation trough further has a second notch, the second coil is positioned within the second notch, the lens base has a second accommodation trough, the second magnet is positioned within the second accommodation trough, and the position of the second notch corresponds to the position of the second accommodation trough.

According to one embodiment of the present invention, the base assembly includes a base and a third coil, the third coil is disposed on the base, the lens base assembly includes a lens base and a third magnet, the third magnet is disposed on the lens base, the third magnet corresponds to the third coil, and the magnetic pole direction of the third magnet is parallel to the third direction.

According to one embodiment of the present invention, the base has a base accommodation trough, the slot side wall of the base accommodation trough further has a third notch, the third coil is positioned within the third notch, the lens base has a third accommodation trough, the third magnet is disposed within the third accommodation trough, and the position of the third notch corresponds to the position of the third accommodation trough.

According to one embodiment of the present invention, the camera structure further includes a spring plate, the spring plate is disposed on the first moving assembly, and the spring plate abuts the top of the lens base assembly.

According to one embodiment of the present invention, the spring plate is arranged along a side of the first moving assembly, the side of the spring plate extends downward to a fixing part, the first moving assembly has a corresponding fixing trough, and the fixing part of the spring plate is fixed within the fixing trough of the first moving assembly.

According to one embodiment of the present invention, the camera structure further includes a circuit board, the circuit board is arranged on a side of the base assembly, and the circuit board is electrically connected to the first coil, the second coil, and the third coil.

### BRIEF DESCRIPTION OF THE DRAWINGS

The accompanying drawings described here are provided to facilitate a further understanding of the present invention and constitute a part of this application. The illustrative embodiments and their descriptions are used to explain the present invention and do not constitute undue limitations on it. In the drawings:

FIG. 1 is a perspective view of the camera structure of an embodiment of the present invention;

FIG. 2 is a sectional view along line A-A′ of FIG. 1;

FIG. 3 is an enlarged view of area D of FIG. 2;

FIG. 4 is a sectional view along line B-B′ of FIG. 1;

FIG. 5 is a sectional view along line C-C′ of FIG. 1;

FIG. 6 is a partially exploded perspective view of the camera structure of an embodiment of the present invention;

FIG. 7 is an enlarged view of area E of FIG. 6;

FIG. 8 is a partially exploded perspective view of the camera structure of an embodiment of the present invention;

FIG. 9 is another partially exploded perspective view of the camera structure of the present invention; and

FIG. 10 is an exploded perspective view of the camera structure of an embodiment of the present invention.

Description in conjunction with the drawings is as follows: 1: camera structure; 11, 11A, 11B, 11C: moving structure; 111, 111A, 111B, 111C: first moving portion; 1111: first groove; 1112: first surface; 112, 112A, 112B, 112C: second moving portion; 1121: second groove; 1122: second surface; 113, 113A, 113B, 113C: moving element; 1131: first end face; 1132: second end face; 1133: inclined lateral surface; 12: imaging lens; 13: base assembly; 131: base; 1310: base accommodation trough; 1311: first notch; 1312: second notch; 1313: third notch; 132: first coil; 133: second coil; 134: third coil; 14: first moving assembly; 141: first moving body; 1411: first accommodation trough; 142: first magnet; 143: fixing trough; 15: second moving assembly; 16: lens base assembly; 161: lens base; 1611: second accommodation trough; 1612: third accommodation trough; 162: second magnet; 163: third magnet; 17: circuit board; 18: spring plate; 181: fixing part; Z: first direction; Y: second direction; X: third direction.

### DETAILED DESCRIPTION OF THE EMBODIMENTS

The following drawings disclose multiple embodiments of the present invention. For the sake of clarity, many implementation details will be described in the following descriptions. However, it should be understood that these implementation details should not be used to limit the present invention. That is to say, in some embodiments of the present invention, these implementation details are not essential. Additionally, for the sake of simplicity in the drawings, some conventional structures and components will be illustrated in a simplified and schematic manner. In the following embodiments, the same reference numerals will be used to denote the same or similar components.

In some embodiments of the present invention, a camera structure uses rolling of a moving element with a first moving portion and a second moving portion to address the issue of excessive friction caused by multiple contact points in conventional ball-based designs.

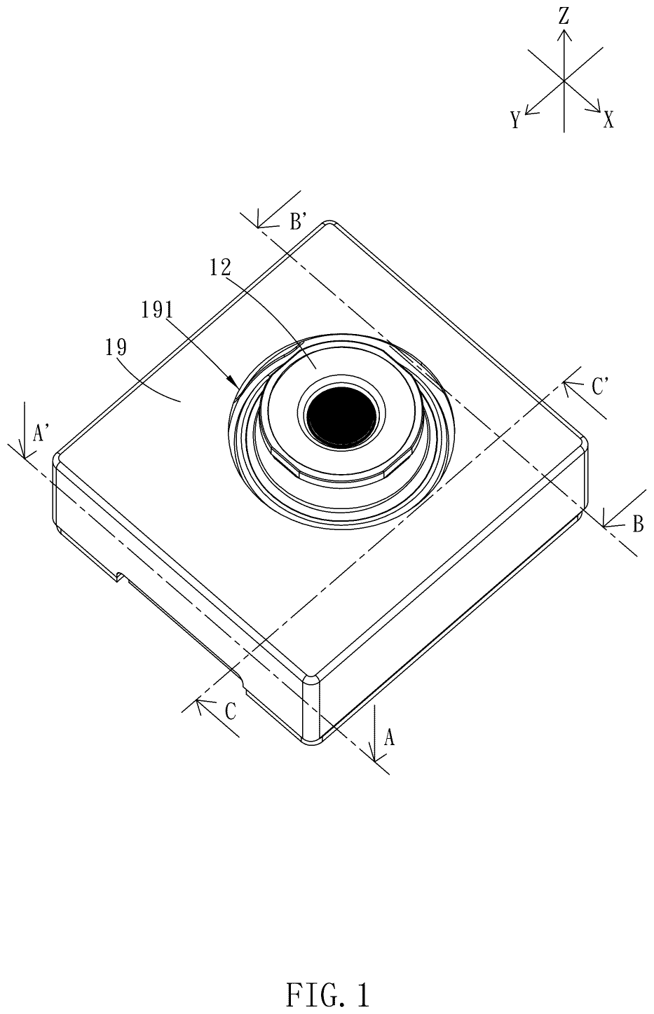

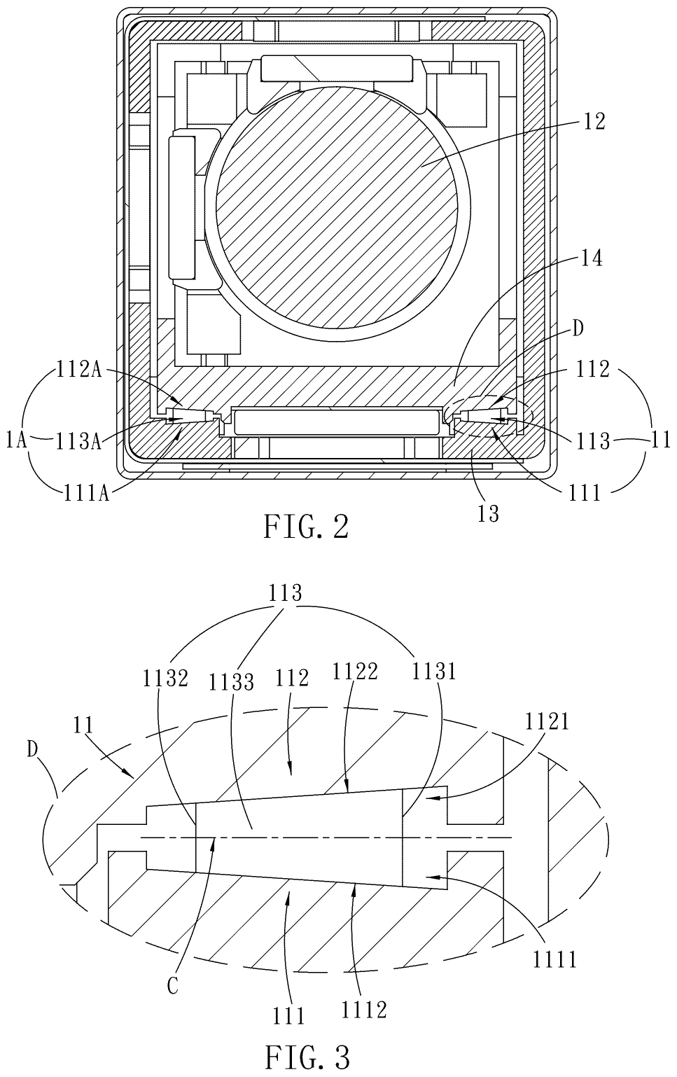

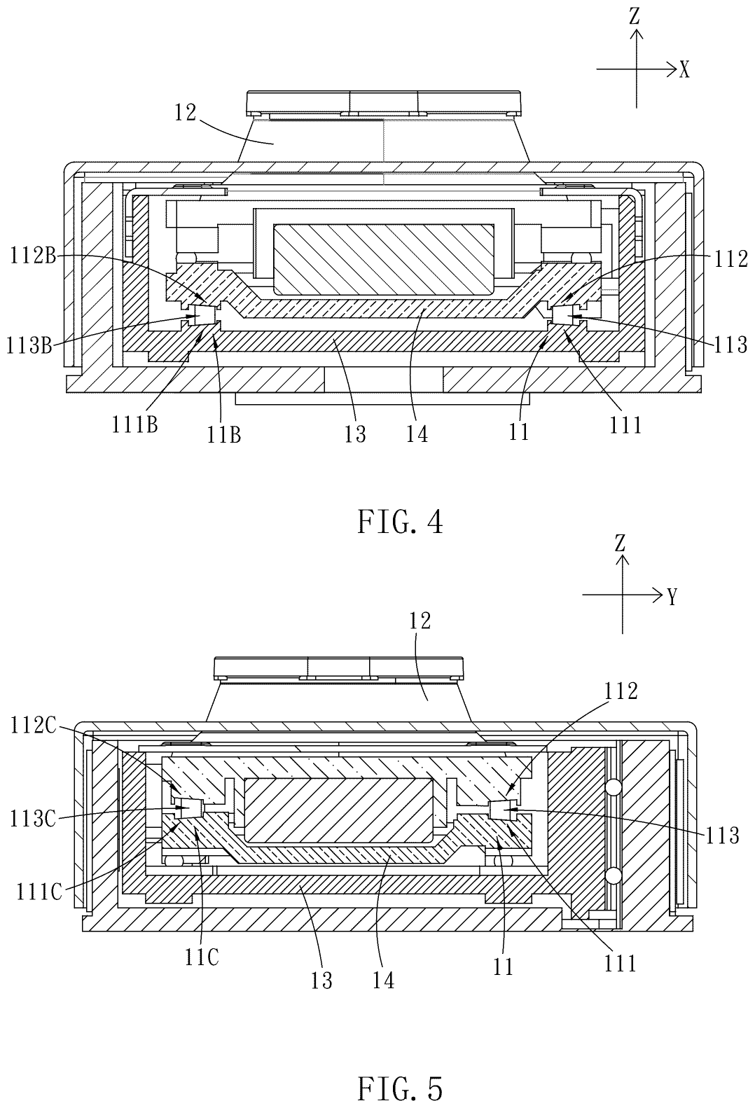

Please refer to FIG. 1 to FIG. 5. FIG. 1 is a perspective view of the camera structure of the present invention, FIG. 2 is a sectional view along line A-A′ of FIG. 1, FIG. 3 is an enlarged view of area D of FIG. 2, FIG. 4 is a sectional view along line B-B′ of FIG. 1, and FIG. 5 is a sectional view along line C-C′ of FIG. 1. As shown in FIG. 1 to FIG. 5, the present invention provides a camera structure 1 including a moving structure 11 and an imaging lens 12. The moving structure 11 includes a first moving portion 111, a second moving portion 112, and a moving element 113. The moving element 113 is disposed between the first moving portion 111 and the second moving portion 112. The moving element 113 includes a first end face 1131, a second end face 1132, and an inclined lateral surface 1133. The first end face 1131 is greater than the second end face 1132. The inclined lateral surface 1133 extends and connects obliquely from a peripheral side of the first end face 1131 to a peripheral side of the second end face 1132. The first moving portion 111 has a first groove 1111, the groove bottom of the first groove 1111 is a first surface 1112, and the first surface 1112 forms an angle with respect to a peripheral side surface of an opening of the first groove 1111. The second moving portion 112 has a second groove 1121, the groove bottom of the second groove 1121 is a second surface 1122, and the second surface 1122 forms an angle with respect to a peripheral side surface of an opening of the second groove 1121. The inclined lateral surface 1133 of the moving element 113 abuts the first surface 1112, another side of the inclined lateral surface 1133 of the moving element 113 abuts the second surface 1122, and the first moving portion 111 and the second moving portion 112 move relative to each other. The moving element 113 moves on the first surface 1112 and the second surface 1122. The imaging lens 12 is displaced by the moving structure 11. The moving structure 11 in this embodiment can provide the imaging lens 12 with the function of autofocus (AF) and/or optical image stabilization (OIS). In some embodiments, the first end face 1131 can be a circular surface or a convex plane; the second end face 1132 can also be a circular surface or a circular plane.

Please refer to FIG. 3. In this embodiment, the two ends of the moving element 113 are the first end face 1131 and the second end face 1132 respectively. The first end face 1131 of an outer end of the moving element 113 is greater than the second end face 1132 of an inner end of the moving element 113, and the shape of the moving element 113 is similar to the shape of a roller, e.g., a tapered roller or a frustum of a cone in some embodiments. The centerline C of the moving element 113 is the connecting line between the center of the first end face 1131 and the center of the second end face 1132. The two side edges of the inclined lateral surface 1133 of the moving element 113 are symmetrical to the centerline C; i.e., the outer diameter of the moving element 113 gradually decreases from the outside to the inside, wherein the inclined lateral surface 1133 forms an angle of less than ninety degrees with the first end face 1131, and the inclined lateral surface 1133 forms an angle of greater than ninety degrees with the second end face 1132.

In this embodiment, the two sides of the moving element 113 are respectively fitted into the first groove 1111 and the second groove 1121 such that the movement of the moving element 113 is constrained by the first groove 1111 and the second groove 1121. The side edges of the two sides of the moving element 113 abut the first surface 1112 of the first groove 1111 and the second surface 1122 of the second groove 1121. In other words, the first surface 1112 of the first moving portion 111 and the second surface 1122 of the second moving portion 112 are also symmetrical to the centerline C of the moving element 113. A side of the inclined lateral surface 1133 of the moving element 113 is in contact with the first surface 1112 and another side of the inclined lateral surface 1133 of the moving element 113 is in contact with the second surface 1122, where the moving element 113 makes linear contact with both the first surface 1112 and the second surface 1122. The moving structure 11 operates by the moving element 113 rolling between the first surface 1112 of the first moving portion 111 and the second surface 1122 of the second moving portion 112. Additionally, the moving element 113 increases the contact area through linear contact, thereby distributing the concentrated stress on the first surface 1112 and the second surface 1122. This design reduces the frictional wear of the moving element 113 against the first surface 1112 and the second surface 1122. The rolling stress of the moving element 113 will be concentrated inward, making it less likely for sliding friction to occur between the moving element 113 and the first groove 1111 and the second groove 1121. This design stabilizes the sliding stability of the moving structure and provides a technical means and effect for extending the service life of the camera structure.

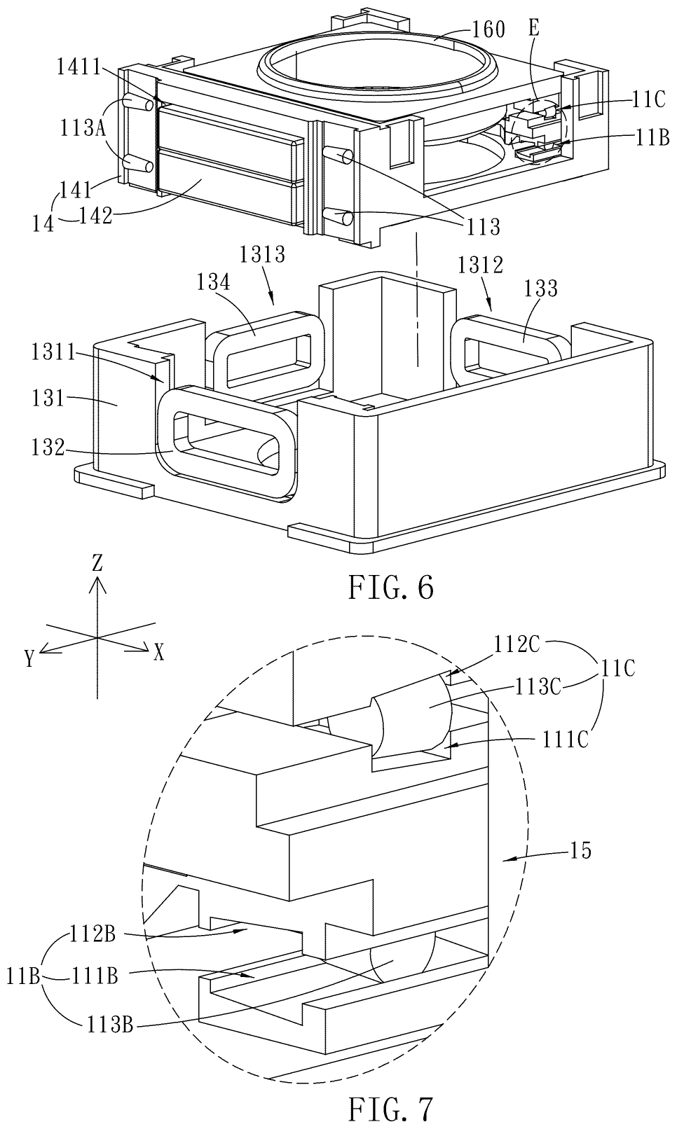

Please refer to FIG. 6. FIG. 6 is a partially exploded perspective view of the camera structure of the present invention. As shown in FIG. 6, in this embodiment, the camera structure 1 further includes a base assembly 13 and a first moving assembly 14. The first moving assembly 14 is disposed within the base assembly 13, the moving structure 11 includes a first moving structure 11A, the first moving structure 11A is positioned between an inner wall of the base assembly 13 corresponding to an outer wall of the first moving assembly 14, the base assembly 13 has a first moving portion 111A, the first moving assembly 14 has second moving portion 112A, and the moving element 113A is positioned between the first moving portion 111A and the second moving portion 112A. In this embodiment, there are multiple moving elements 113, and the multiple moving elements 113 are positioned on both sides of the camera structure 1. The multiple moving elements 113 on both sides are arranged such that their second end faces 1132 corresponding to each other. Multiple moving elements 113 are arranged along the first direction Z between the base assembly 13 and the first moving assembly 14. The first moving structure 11A guides the first moving assembly 14 to reciprocate in the first direction Z (i.e., the vertical direction) relative to the base assembly 13.

Furthermore, the base assembly 13 includes a base 131 and a first coil 132, and the first coil 132 is disposed on the base 131. The first moving assembly 14 includes a first moving body 141 and a first magnet 142. The first magnet 142 is disposed on the first moving body 141. The first coil 132 corresponds to the first magnet 142, and the magnetic pole direction of the first magnet 142 is parallel to the first direction Z. The base 131 has a base accommodation trough 1310, the trough side wall of the base accommodation trough 1310 has a first notch 1311, and the first coil 132 is disposed within the first notch 1311. The first moving body 141 has a first accommodation trough 1411, the first magnet 142 is disposed within the first accommodation trough 1411, and the position of the first notch 1311 corresponds to the position of the first accommodation trough 1411.

As described above, the magnetic poles of the first magnet 142 are arranged in a manner parallel to the first direction Z, meaning the north pole and the south pole are aligned in the vertical direction. When current flows through the first coil 132 and a corresponding magnetic field is generated accordingly, the magnetic field of the first coil 132 interacts with the magnetic poles of the first magnet 142 relatively. This interaction produces either a repulsion or attraction force on the first moving assembly 14 relative to the base 131. Consequently, the first moving assembly 14 moves against the multiple moving elements 113A relative to the base 131. Furthermore, the first moving assembly 14 is driven to generate reciprocating displacement relative to the base 131 in the first direction Z. In this way, the imaging lens 12 is displaced by the first moving structure 11A, achieving the autofocus function of the camera structure 1.

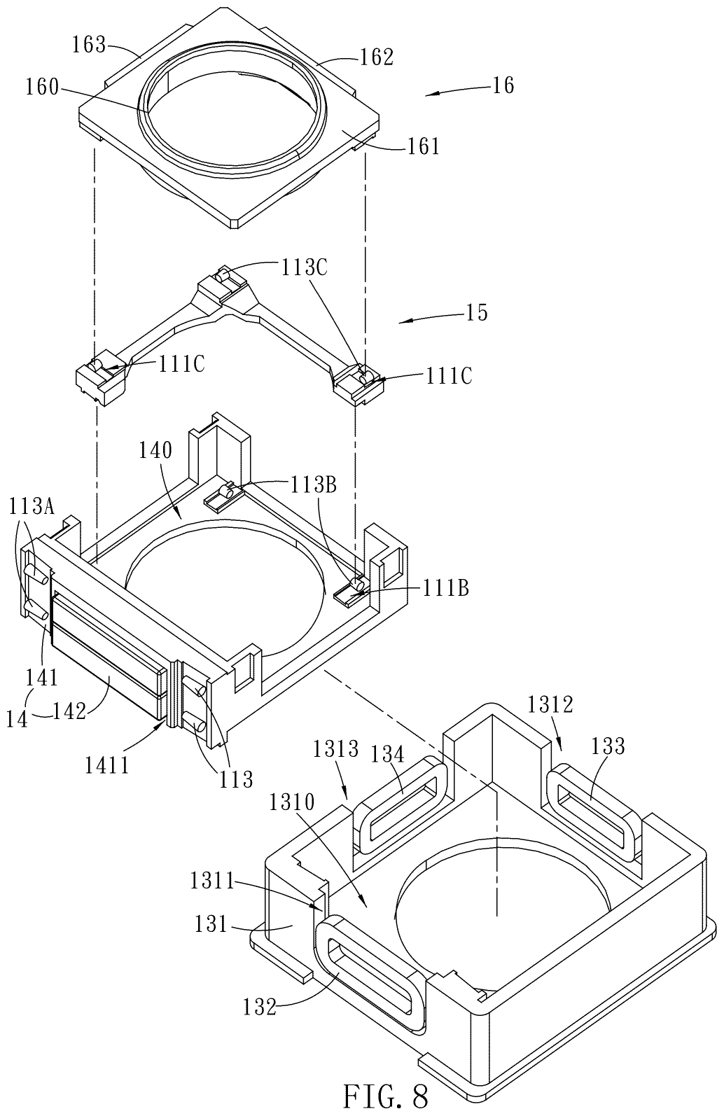

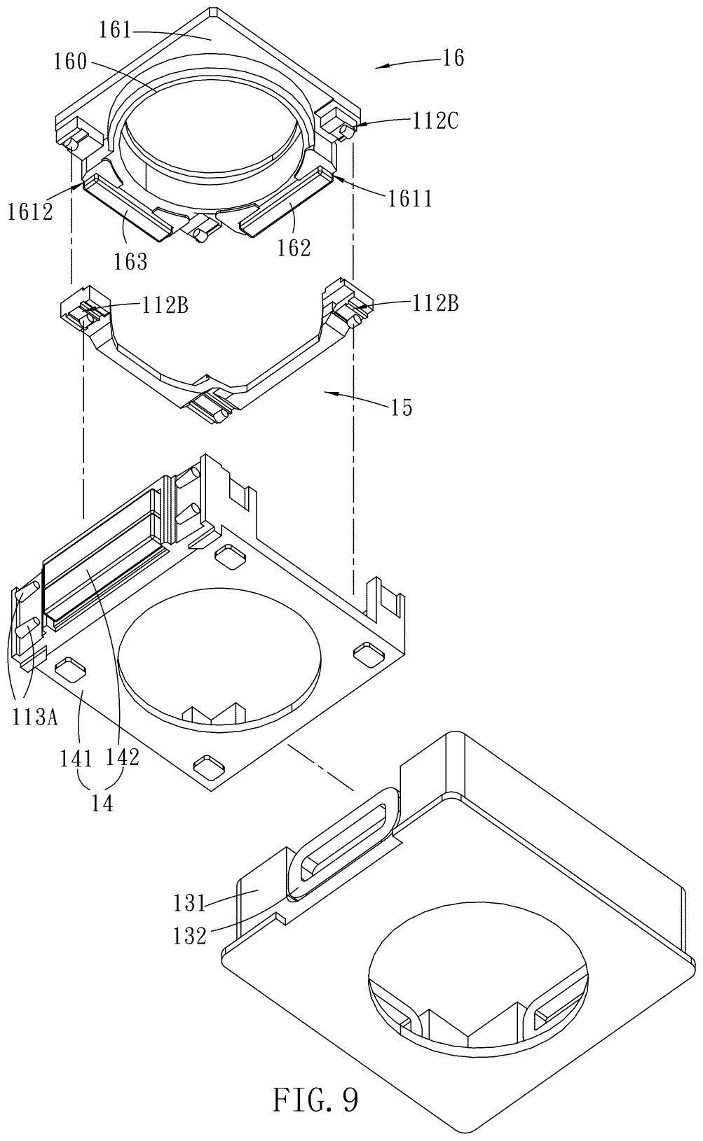

Please refer to FIG. 7 to FIG. 9. FIG. 7 is an enlarged view of area E of FIG. 6, FIG. 8 is a partially exploded perspective view of the camera structure of the present invention, and FIG. 9 is another partially exploded perspective view of the camera structure of the present invention. As shown in FIG. 7 to FIG. 9, the camera structure further includes a second moving assembly 15, the moving structure 11 includes a second moving structure 11B, the first moving assembly 14 has a concave accommodation slot 140, the second moving assembly 15 is disposed within the concave accommodation slot 140 of the first moving assembly 14, and the second moving structure 11B is positioned between the concave accommodation slot 140 of the first moving assembly 14 and the corresponding bottom portion of the second moving assembly 15. The first moving assembly 14 has a first moving portion 111B, the second moving assembly 15 has a second moving portion 112B, the second moving structure 11B guides the second moving assembly 15 to move reciprocally in the second direction Y (i.e., the horizontal direction) relative to the first moving assembly 14, and the second direction Y is perpendicular to the first direction Z.

As described above, in this embodiment, there are three moving elements 113B, and the groove bottom of the concave accommodation slot 140 of the first moving assembly 14 has three first moving portions 111B. The second moving assembly 15 has an L-shaped structure, with the second moving portion 112B positioned at both ends and at the corner of the L shape of the second moving assembly 15. The three moving elements 113B form a movable supporting horizontal plane and are correspondingly assembled between the second moving portion 112B of the second moving assembly 15 and the first moving portion 111B of the first moving assembly 14.

In this embodiment, the camera structure 1 further includes a lens base assembly 16, the moving structure 11 includes a third moving structure 11C, the lens base assembly 16 is disposed on the second moving assembly 15, and the third moving structure 11C is positioned between a top portion of the second moving assembly 15 corresponding to the bottom portion of the lens base assembly 16. The second moving assembly 15 has a first moving portion 111C, the lens base assembly 16 has a second moving portion 112C, and the third moving structure 11C guides the lens base assembly 16 to move reciprocally in a third direction X (i.e., the horizontal direction) relative to the second moving assembly 15. The third direction X and the second direction Y are perpendicular to each other. Moreover, the third direction X and the first direction Z are also perpendicular to each other.

As described above, in this embodiment, there are three moving elements 113C. The second moving assembly 15 has an L-shaped structure. The locations of the three moving elements 113C correspond to the locations of the three moving elements 113B. The three moving elements 113C are also positioned at both ends and at the corner of the L shape of the second moving assembly 15. The three moving elements 113C form a movable supporting horizontal plane. The lens base assembly 16 is the lens frame that holds the imaging lens 12. The second moving portion 112C is positioned at the three corner locations of the bottom of the lens base assembly 16. The three moving elements 113C are correspondingly assembled between the second moving assembly 15 and the lens base assembly 16.

In this embodiment, the second moving structure 11B and the third moving structure 11C are used to provide displacement in the horizontal direction. The second end face 1132 of each of the multiple moving elements 113B of the second moving structure 11B faces inward. Similarly, the second end face 1132 of each of the multiple moving elements 113C of the third moving structure 11C also faces inward. Additionally, in this embodiment, the imaging lens 12 is disposed on the lens base assembly 16, wherein the lens base assembly 16 has an assembly hole 160. The imaging lens 12 is fitted into the assembly hole 160 such that the imaging lens 12 can be moved by the base assembly 13, the first moving assembly 14, the second moving assembly 15, and the lens base assembly 16.

In this embodiment, the base assembly 13 includes a base 131 and a second coil 133, and the second coil 133 is disposed on the base 131, wherein the trough side wall of the base accommodation trough 1310 of the base 131 further has a second notch 1312. The first notch 1311 and the second notch 1312 are located on different trough side walls of the base accommodation trough 1310. The second coil 133 is located within the second notch 1312. The lens base assembly 16 includes a lens base 161 and the second magnet 162, and the second magnet 162 is disposed within the lens base 161. The lens base 161 has a second accommodation trough 1611, and the second magnet 162 is disposed within the second accommodation trough 1611. The location of the second notch 1312 corresponds to the location of the second accommodation trough 1611. Thus, the second magnet 162 is corresponded to the second coil 133, and the magnetic pole direction of the second magnet 162 is oriented parallel to the second direction Y; i.e., the south pole and the north pole of the magnet are oriented in the horizontal direction. When a current passes through the second coil 133, the magnetic pole of the second coil 133 interacts with the magnetic pole of the second magnet 162, causing the second magnet 162 to be acted upon by an attraction or repulsion force relative to the second coil 133. Consequently, the lens base assembly 16 moves in the second direction Y via the second moving structure 11B between the second moving assembly 15 and the first moving assembly 14. More specifically, the lens base assembly 16 and the second moving assembly 15 are driven to perform reciprocating displacement relative to the first moving assembly 14 in the second direction Y. Because the third moving structure 11C restricts and guides the lens base assembly 16 to reciprocate only relative to the second moving assembly 15 in the third direction X (as shown in FIG. 6 and FIG. 7), the lens base assembly 16 and the second moving assembly 15 do not move relative to each other in the second direction Y when the second coil 133 and the second magnet 162 interact to drive the lens base assembly 16 and the second moving assembly 15 to reciprocate relative to the first moving assembly 14 in the second direction Y.

Furthermore, the base assembly 13 includes a base 131 and a third coil 134, and the third coil 134 is disposed on the base 131, wherein the trough side wall of the base accommodation trough 1310 of the base 131 further has a third notch 1313. The first notch 1311, the second notch 1312, and the third notch 1313 are each located on different trough side walls of the base accommodation trough 1310. The third coil 134 is located within the third notch 1313. The lens base assembly 16 includes a lens base 161 and a third magnet 163, wherein the third magnet 163 is disposed on the lens base 161. The lens base 161 has a third accommodation trough 1612. The third magnet 163 is disposed within the third accommodation trough 1612. The location of the third notch 1313 corresponds to the location of the third accommodation trough 1612. Therefore, the third coil 134 corresponds to the third magnet 163, and the magnetic pole direction of the third magnet 163 is parallel to the third direction X. When a current passes through the third coil 134, the magnetic pole of the third coil 134 interacts with the magnetic pole of the third magnet 163, causing third magnet 163 to be acted upon by an attraction or a repulsion force relative to the third coil 134. Consequently, the lens base assembly 16 moves in the third direction X via the third moving structure 11C. More specifically, the lens base assembly 16 is driven to perform reciprocating displacement relative to the second moving assembly 15 in the third direction X. Because the second moving structure 11B restricts and guides the second moving assembly 15 to reciprocate only relative to the first moving assembly 14 in the second direction Y (as shown in FIG. 6 and FIG. 7), the second moving assembly 15 and the first moving assembly 14 do not move relative to each other in the third direction X when the third coil 134 and the third magnet 163 interact to drive the lens base assembly 16 to reciprocate relative to the second moving assembly 15 in the third direction X. Thus, the imaging lens 12 moves via the second moving structure 11B and the third moving structure 11C, providing the optical image stabilization function of the camera structure 1.

In this embodiment, the moving structure 11 includes a first moving structure 11A, a second moving structure 11B, and a third moving structure 11C. The first moving structure 11A, the second moving structure 11B, and the third moving structure 11C all have the same structure (as shown in FIG. 3). The first moving structure 11A is responsible for reciprocating movement in the first direction Z, the second moving structure 11B is used for reciprocating displacement in the second direction Y, and the third moving structure 11C is used for reciprocating displacement in the third direction X. The purpose of the above-mentioned moving structure 11 is to provide three-axis directional movement adjustment of the imaging lens 12.

Please refer back to FIG. 6. The camera structure 1 further includes a circuit board 17, the circuit board 17 is arranged on a side of the base assembly 13, and the circuit board 17 is arranged on a side of the first coil 132, the second coil 133, and the third coil 134. The circuit board 17 is electrically connected to the first coil 132, the second coil 133, and the third coil 134. In addition, the camera structure 1 further includes a spring plate 18, the spring plate 18 is disposed on the first moving assembly 14, and the spring plate 18 abuts the top of the lens base assembly 16. The spring plate 18 is arranged along three sides of the first moving assembly 14. A fixing part 181 is extended downward from an edge of the spring plate 18. In some embodiments, there are three fixing parts 181 respectively extended from three edges of the spring plate 18. The first moving assembly 14 has a corresponding fixing trough 143, and the fixing part 181 of the spring plate 18 is correspondingly fixed within the fixing trough 143 of the first moving assembly 14. The spring plate 18 can be used to restrict the movement range of the lens base assembly 16 corresponding to the first moving assembly 14 in the third direction X and/or the second direction Y. The spring plate 18 serves to limit the movement range of the lens base assembly 16 and the imaging lens 12 in the first direction Z (i.e., the focusing movement range), while also ensuring that the lens base assembly 16 is assembled within the first moving assembly 14.

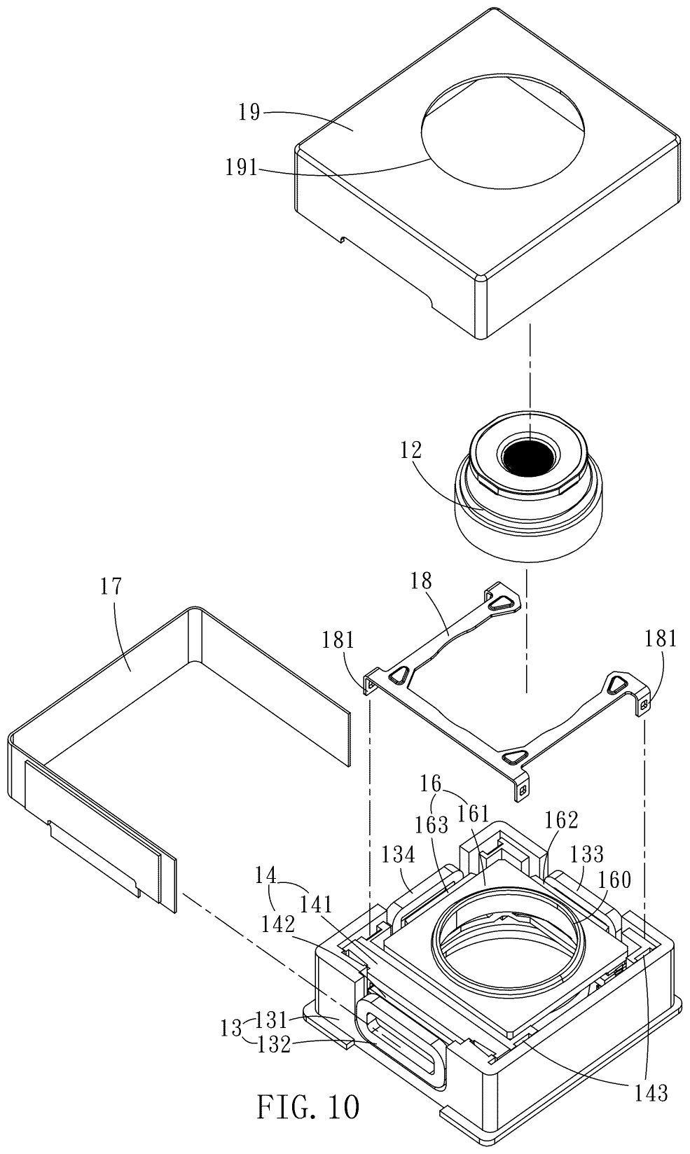

Please refer to FIG. 10. FIG. 10 presents an exploded perspective view of the camera structure. The camera structure 1 further includes a protective cover 19, and the protective cover 19 has an orifice 191. The protective cover 19 is placed over the base assembly 13, sealing the first moving assembly 14, the second moving assembly 15, the lens base assembly 16, the circuit board 17, and the spring plate 18 within the base assembly 13, with the imaging lens 12 of the lens base assembly 16 extending through the orifice 191 of the protective cover 19.

In some embodiments of the present invention. a camera structure in which the inclined lateral surface of the moving element is in contact with the first surface of the first moving portion. The inclined lateral surface and the first surface are in linear contact with each other. The other side of the inclined lateral surface of the moving element is in contact with the second surface of the second moving portion, where the inclined lateral surface and the second surface are also in linear contact with each other. The first moving portion moves relative to the second moving portion such that the moving element can move between the first surface and the second surface. The moving element makes linear contact with the first surface and the second surface, thereby distributing and not concentrating the surface stress of the moving element on the first surface and the second surface compared to point contact. Furthermore, the peripheral side of the moving element is an oblique extension that gradually decreases in size, and the rolling stress of the moving element is concentrated inward to stabilize the sliding stability of the moving structure.

It should also be noted that the terms “comprise”, “includes” or any other variation thereof are intended to cover non-exclusive inclusion, such that a process, method, product, or apparatus that includes a list of elements not only includes those elements but may also include other elements not expressly listed or inherent to such process, method, product, or apparatus. Without additional limitations, an element defined by the phrase “including a . . . ” does not exclude the presence of additional identical elements in the process, method, product, or apparatus that includes the element.

The above description illustrates and describes several embodiments of the present invention. However, it should be understood that the present invention is not limited to the forms disclosed herein and should not be construed as excluding other embodiments. It can be applied to various other combinations, modifications, and environments and can be adapted within the scope of the inventive concepts presented here, based on the teachings provided or the knowledge and techniques in the relevant field. Any modifications and variations made by those skilled in the art that do not depart from the spirit and scope of the present invention are intended to be within the scope of the appended claims.

What is claimed is:

1. A camera structure, comprising:
a moving structure, comprising a first moving portion, a second moving portion, and a moving element, the moving element being disposed between the first moving portion and the second moving portion, the moving element comprising a first end face, a second end face and an inclined lateral surface, the first end face being greater than the second end face, the inclined lateral surface extending and connecting obliquely from a peripheral side of the first end face to a peripheral side of the second end face, the first moving portion having a first groove, the groove bottom of the first groove being a first surface, the first surface forming an angle with respect to a peripheral side surface of an opening of the first groove, the second moving portion having a second groove, the groove bottom of the second groove being a second surface, the second surface forming an angle with respect to a peripheral side surface of an opening of the second groove, the inclined lateral surface of the moving element abutting the first surface, another side of the inclined lateral surface of the moving element abutting the second surface, the first moving portion and the second moving portion moving relative to each other, and the moving element moving on the first surface and the second surface; and
an imaging lens, configured to be displaced by the moving structure.

2. The camera structure as claimed in claim 1, wherein the first surface and the second surface is symmetrical with respect to a line connecting the center of the first end face and the center of the second end face of the moving element.

3. The camera structure as claimed in claim 1, wherein the first end face is a circular plane, the second end face is a circular plane, the inclined lateral surface forms an angle of less than ninety degrees with the first end face, and the inclined lateral surface forms an angle of greater than ninety degrees with the second end face.

4. The camera structure as claimed in claim 1, further comprising a base assembly and a first moving assembly, the first moving assembly being disposed within the base assembly, the moving structure comprising a first moving structure, the first moving structure being positioned between an inner wall of the base assembly and a corresponding outer wall of the first moving assembly, the base assembly having a first moving portion, the first moving assembly having a second moving portion, and the first moving structure guiding the first moving assembly to move reciprocally in a first direction relative to the base assembly.

5. The camera structure as claimed in claim 4, wherein the base assembly comprises a base and a first coil, the first coil is disposed on the base, the first moving assembly comprises a first moving body and a first magnet, the first magnet is disposed on the first moving body, the first coil corresponds to the first magnet, and a magnetic pole direction of the first magnet is parallel to the first direction.

6. The camera structure as claimed in claim 5, wherein the base has a base accommodation trough, a trough side wall of the base accommodation trough has a first notch, the first coil is disposed within the first notch, the first moving body has a first accommodation trough, the first magnet is disposed within the first accommodation trough, and the position of the first notch corresponds to the position of the first accommodation trough.

7. The camera structure as claimed in claim 4, further comprising a second moving assembly, the moving structure comprising a second moving structure, the first moving assembly having a concave accommodation slot, the second moving assembly being disposed within the concave accommodation slot of the first moving assembly, the second moving structure being positioned within the concave accommodation slot of the first moving assembly corresponding to the bottom portion of the second moving assembly, the first moving assembly having a first moving portion, the second moving assembly having a second moving portion, the second moving structure guiding the second moving assembly to move reciprocally in a second direction relative to the first moving assembly, and the second direction being perpendicular to the first direction.

8. The camera structure as claimed in claim 7, further comprising a lens base assembly, the moving structure comprising a third moving structure, the lens base assembly being disposed on the second moving assembly, the third moving structure being positioned between a top portion of the second moving assembly and the bottom portion of the lens base assembly, the second moving assembly having a first moving portion, the lens base assembly having a second moving portion, the third moving structure guiding the lens base assembly to move reciprocally in a third direction relative to the second moving assembly, and the third direction and the second direction being perpendicular to each other.

9. The camera structure as claimed in claim 8, wherein the imaging lens is disposed on the lens base assembly.

10. The camera structure as claimed in claim 8, wherein the base assembly comprises a base and a second coil, the second coil is disposed on the base, the lens base assembly comprises a lens base and a second magnet, the second magnet is disposed on the lens base, the second magnet corresponds to the second coil, and a magnetic pole direction of the second magnet is parallel to the second direction.

11. The camera structure as claimed in claim 10, wherein the base has a base accommodation trough, a slot side wall of the base accommodation trough has a second notch, the second coil is positioned within the second notch, the lens base has a second accommodation trough, the second magnet is positioned within the second accommodation trough, and a position of the second notch corresponds to the position of the second accommodation trough.

12. The camera structure as claimed in claim 8, wherein the base assembly comprises a base and a third coil, the third coil is disposed on the base, the lens base assembly comprises a lens base and a third magnet, the third magnet is disposed on the lens base, the third magnet corresponds to the third coil, and the magnetic pole direction of the third magnet is parallel to the third direction.

13. The camera structure as claimed in claim 12, wherein the base has a base accommodation trough, the slot side wall of the base accommodation trough further has a third notch, the third coil is positioned within the third notch, the lens base has a third accommodation trough, the third magnet is disposed on the third accommodation trough, and the position of the third notch corresponds to the position of the third accommodation trough.

14. The camera structure as claimed in claim 8, further comprising a spring plate, the spring plate being disposed on the first moving assembly and abutting the top of the lens base assembly.

15. The camera structure as claimed in claim 14, wherein the spring plate is arranged along a side of the first moving assembly, a fixing part is extended downward from an edge of the spring plate, the first moving assembly has a corresponding fixing trough, and the fixing part of the spring plate is fixed within the fixing trough of the first moving assembly.

16. The camera structure as claimed in claim 1, further comprising a circuit board, the circuit board being arranged on a side of the base assembly, and the circuit board being electrically connected to the first coil, the second coil, and the third coil respectively.
